(19) United States
(12) Patent Application Publication
(10) Pub. No.: US 2007/0275251 A1
(43) Pub. Date: Nov. 29, 2007

(54) UV-TREATED WOODEN TOOL HANDLE

(76) Inventor: Yung-Shou Chen, Long-Ching Town (TW)

Correspondence Address: PAI PATENT & TRADEMARK LAW FIRM, 1001 FOURTH AVENUE, SUITE 3200, SEATTLE, WA, 98154, US

(21) Appl. No.: 11/420,542

(22) Filed: May 26, 2006

(51) Int. Cl. B32B 27/40

(52) U.S. Cl. 428/425.1

(57) ABSTRACT

A UV-treated tool handle having a base layer of dark polyurethane coating coated on the surface of a wooden handle body thereof, an intermediate layer of transparent polyurethane coating coated on the base layer of dark polyurethane coating, and an outer layer of UV spray paint coated on the intermediate layer of transparent polyurethane coating, wherein the tool handle has been radiated with ultraviolet rays.

### BACKGROUND OF THE INVENTION

(a) Field of the Invention

The present invention relates to a handle of a hand tool and more particularly to an UV-treated wooden tool handle.

(b) Description of the Prior Art

The wooden handle of a regular hand tool, for example, a hammer, generally has the surface coated with a layer of base coating and then coated with a layer of protective cover coating after hardening of the base coating through a baking process. A wooden tool handle made according to this method is not durable in use due to its low weather and abrasion resistance. Further, because of low friction force, this wooden tool handle may easily slip from the user's hand during working, and the hand tool cannot be accurately manipulated by the user.

Weather resistance of a material is the capability of the material to withstand sunlight, wind, rain and moisture. A wooden tool handle of low weather resistance decays quickly under the weather. In order to enhance the wear resistant power, a wooden tool handle must be coated with weatherproof coatings.

### SUMMARY OF THE INVENTION

The present invention has been accomplished under the circumstances in view. According to one embodiment of the present invention, the UV-treated wooden tool handle comprises a wooden handle body, a base layer of dark polyurethane coating coated on the surface of the wooden handle body, and an outer layer of UV spray paint coated on the base layer of dark polyurethane coating and has been radiated with ultraviolet rays. According to another embodiment of the present invention, the UV-treated wooden tool handle further comprises an intermediate layer of transparent polyurethane coating sandwiched in between the base layer of dark polyurethane coating and the outer layer of UV spray paint.

### BRIEF DESCRIPTION OF THE DRAWINGS

FIG. 1 is a side view of a wooden tool handle in accordance with the present invention.

FIG. 2 is a cross-sectional view of the wooden tool handle in accordance with the present invention.

FIG. 3 is a block diagram showing the steps of manufacturing a wooden tool handle according to one embodiment of the present invention.

FIG. 4 is a block diagram showing the steps of manufacturing a wooden tool handle according to another embodiment of the present invention.

### DETAILED DESCRIPTION OF THE PREFERRED EMBODIMENTS

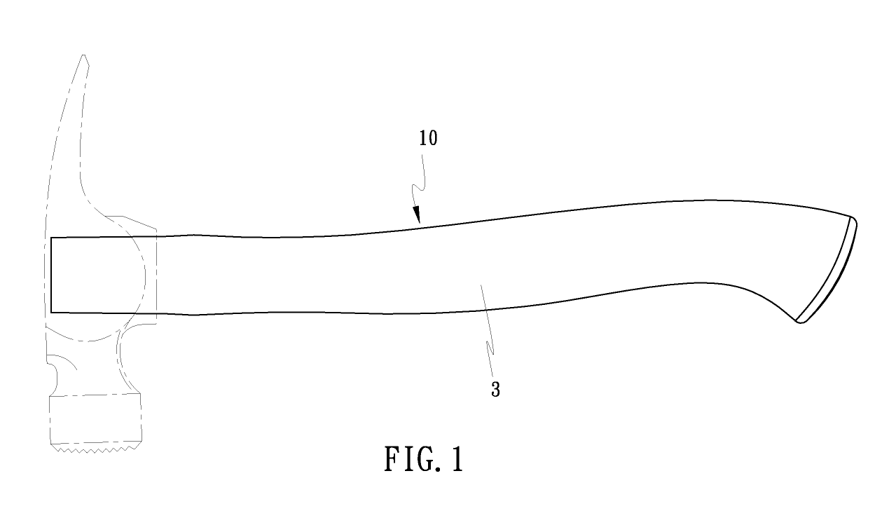

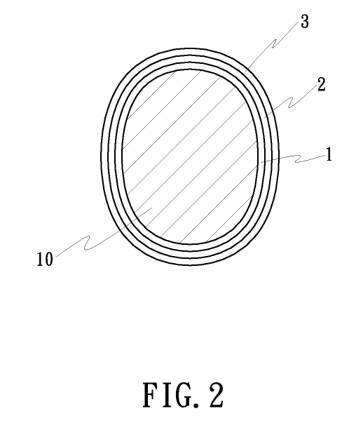

Referring to FIGS. 1 and 2, a wooden tool handle 10 of a hand tool (for example, a hammer) is shown coated with a base layer of dark polyurethane coating 1, an intermediate layer of transparent polyurethane coating 2, and an outer layer of UV spray paint 3. The outer UV spray paint 3 is further radiated with ultraviolet rays. According to abrasion and weather tests, the wooden tool handle 10 shows a satisfactory result. Therefore, this design of wooden tool handle 10 is durable in use. Further, the wooden tool handle 10 does not slip when it is held in the user's hand during working.

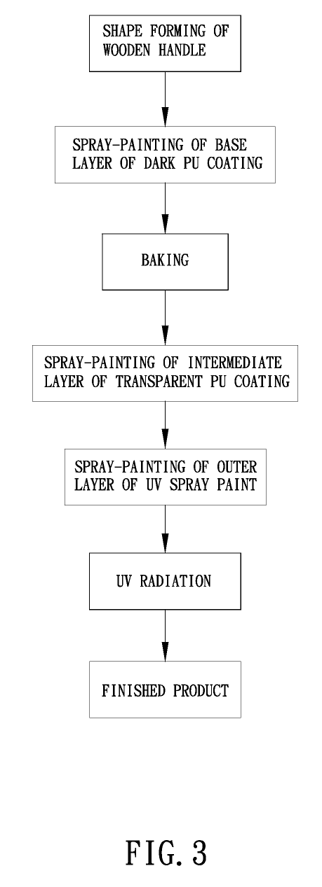

FIG. 3 is a block diagram showing steps of manufacturing a wooden tool handle according to one embodiment of the present invention. According to this embodiment, the fabrication flow includes the steps of (a) forming a blank wooden handle according to the desired shape, (b) spray-painting the blank wooden handle with a base layer of dark polyurethane coating, (c) baking the coated wooden tool handle, (d) spray-painting over the base layer of dark polyurethane coating with an intermediate layer of transparent polyurethane coating, (e) spray-paining over the intermediate layer of transparent polyurethane coating with an outer layer of UV spray paint, and (f) radiating the UV spray paint-coated wooden tool handle with ultraviolet rays.

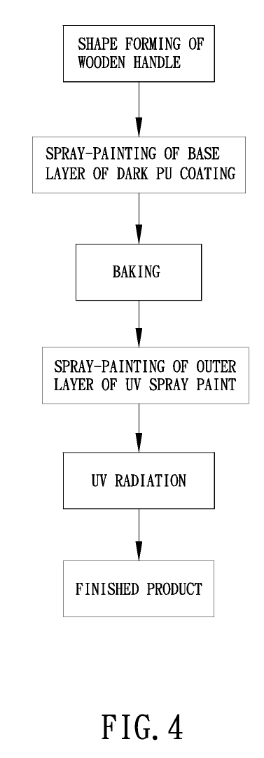

FIG. 4 is a block diagram showing the steps of manufacturing a wooden tool handle according to another embodiment of the present invention. According to this embodiment, the fabrication flow includes the steps of (a) forming a blank wooden handle subject to the desired shape, (b) spray-painting the blank wooden handle with a base layer of dark polyurethane coating, (c) baking the coated wooden tool handle, (d) spray-painting over the base layer of dark polyurethane coating with an outer layer of UV spray paint, and (e) radiating the UV spray paint-coated wooden tool handle with ultraviolet rays.

The aforesaid intermediate layer of transparent polyurethane coating 2 is an interface substance. The outer layer of UV spray paint 3 constitutes the covering of the wooden tool handle 10, enhancing the weather and abrasion resistance of the wooden tool handle 10.

During the spray painting process of the intermediate layer of transparent polyurethane coating 2 and the outer layer of UV spray paint 3, the wooden hand tool 10 is firmly secured in position in a clean room and then spray-painted with the intermediate layer of transparent polyurethane coating 2 and then the outer layer of UV spray paint 3 after drying of the intermediate layer of transparent polyurethane coating 2 through a baking process. After coating, the wooden hand tool 10 is put in an UV radiator and radiated with ultraviolet rays to harden the outer layer of UV spray paint 3.

Through weather test and abrasion tests, the test wooden tool handle samples made according to the present invention show the following results:

### 1. Abrasion Test

a. Test load: 900 g.

b. Test speed: 55 cycle/min.

c. Count: 3000 cycles.

Test Result Test samples of the present invention yielded 4˜5 grades, compared to 1 grade for test samples of the prior art (subject to ISO 105X 12-93).

### 2. Weather Test

a. Wavelength: 340 nm.

b. Typical irradiance: 0.35 W/m2/nm.

c. Circulation: radiation 102 minutes (blackboard temperature 63±2.5oC; spraying water 18 minutes.

d. Test time: 24 hours.

Test Result Test samples of the present invention showed no significant surface abnormality; test samples of the prior art showed breaking of coating (subject to ASTM G155-00a).

A prototype of UV-treated wooden tool handle has been constructed with the features of FIGS. 1˜4. The UV-treated wooden tool handle functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A UV-treated wooden tool handle which comprises a wooden handle body, a base layer of dark polyurethane coating coated on the surface of said wooden handle body, and an outer layer of UV spray paint; and which has been radiated with ultraviolet rays.

2. A UV-treated wooded tool handle as claimed in claim 1, wherein said outer layer of UV spray paint is coated on said base layer of dark polyurethane coating.

3. A UV-treated wooden tool handle as claimed in claim 1, further comprising an intermediate layer of transparent polyurethane coating sandwiched in between said base layer of dark polyurethane coating and said outer layer of UV spray paint.

4. A method of making a UV-treated wooden tool handle, comprising:
(a) forming a blank wooden handle of a predetermined shape;
(b) spray-painting the blank wooden handle with a base layer of dark polyurethane coating to yield a base-coated wooden tool handle;
(c) baking the base-coated wooden tool handle from step (b);
(d) spray-painting over the base layer of dark polyurethane coating with an outer layer of UV spray paint; and
(e) radiating the UV spray paint-coated wooden tool handle from (d) with ultraviolet ray.

5. A method of making a UV-treated wooden tool handle, comprising:
(a) forming a blank wooden handle of a predetermined shape;
(b) spray-painting the blank wooden handle with a base layer of dark polyurethane coating to yield a base-coated wooden tool handle;
(c) baking the base-coated wooden tool handle from step (b);
(d) spray-painting over the base layer of dark polyurethane coating with an intermediate layer of transparent polyurethane coating;
(e) spray-paining over the intermediate layer of transparent polyurethane coating with an outer layer of UV spray paint; and
(f) radiating the UV spray paint-coated wooden tool handle from (e) with ultraviolet ray.
